(19) United States
(12) Patent Application Publication
(10) Pub. No.: US 2016/0181862 A1
(43) Pub. Date: Jun. 23, 2016

(54) ENERGIZING A POWER SUPPLY IN RESPONSE TO A DISABLEMENT OF A RELAY

(71) Applicant: HEWLETT PACKARD ENTERPRISE DEVELOPMENT LP, Houston, TX (US)

(72) Inventors: Daniel Humphrey, Cypress, TX (US); Mohamed Amin Bemat, Cypress, TX (US); Samantha Jean Castillo, Houston, TX (US)

(21) Appl. No.: 14/910,303

(22) PCT Filed: Sep. 27, 2013
(86) PCT No.: PCT/US2013/062156

§ 371 Date: Feb. 5, 2016

(51) Int. Cl. H02J 9/06

(52) U.S. Cl. CPC H02J 9/06

(57) ABSTRACT

Examples, disclosed herein, energize a first power supply through an enablement of a first relay to provide power to a load while a second power supply remains de-energized through a disablement of a second relay. Additionally, the examples detect a fault associated with the first power supply and de-energize the first power supply through a disablement of the first relay. Further, the examples energize the second power supply through an enablement of the second relay to provide power to the load, in response to the disablement of the first relay.

### BACKGROUND

As technology increases, there is a greater dependence on providing reliability within a power system. The power system may include a redundant power supply to minimize losses when a power supply fails.

### BRIEF DESCRIPTION OF THE DRAWINGS

In the accompanying drawings, like numerals refer to like components or blocks. The following detailed description references the drawings, wherein:

FIG. 1 is a block diagram of an example power system including a first power supply to enable power to a load through an enablement of a first relay, the example power system further including a second power supply to enable a second relay to provide power to the load in response to a disablement of the first relay;

FIG. 2 is a circuit diagram of an example power system including a first power supply and a second power supply connected to an output converter to provide power to a load, each power supply further including a bridge rectifier to receive alternating current and deliver direct current through multiple diodes to the output converter;

FIG. 3 is a flowchart of an example method to energize a first power supply by an enablement of a first relay, detect a fault associated with the first power supply, de-energize the first power supply through a disablement of the first relay, and energize a second power supply through an enablement of a second relay;

FIG. 4 is a flowchart of an example method to disable a first and a second relay, energize a first power supply through the first relay, detect a fault associated with the first power supply, and energize a second power supply through the second relay, accordingly; and

FIG. 5 is a block diagram of an example computing device with a processor to execute instructions in a machine-readable storage medium for disabling a first and a second relay and energizing/de-energizing a first and a second power supply through the first and the second relay, accordingly.

### DETAILED DESCRIPTION

A redundant power supply may protect a system when an unexpected power disruption in a main power supply occurs. The redundant power supply and the main power supply may be non-isolated and connected in parallel. The non-isolation and parallel connections between the power supplies may cause current leakage. For example, the components within each power supply are rated for a limited amount of power, thus if power (e.g., current) may leak from one faulted power supply to the other non-faulted power supply, this may cause additional component break-down and/or failure in the non-faulted power supply.

To address these issues, implementations disclosed herein provide power isolation between a first power supply and a second power supply. The implementation enables a first relay to energize the first power supply to provide power to a load while the second power supply remains disabled through a disablement of a second relay. The implementation may detect a fault associated with the first power supply and disable the first relay to de-energize the first power supply. In response to the disablement of the first relay, the second power supply may be energized through an enablement of the second relay to provide the power to the load rather than the first power supply. Energizing and de-energizing power supplies based on enabling and disabling the relays prevents the fault from the first power supply to affect the second power supply. This provides reliability to ensure the power system may operate with minimal losses and/or disruption. Additionally, enabling and disabling the relays to energize and de-energize the power supplies provides a control aspect to a power sequencing of the power supplies.

In another implementation disclosed herein, the power system may include multiple diodes to provide additional power isolation between the power supplies. The additional power isolation enables a reliability to prevent the power leakage to the faulted power supply from other components within the power system.

In a further implementation, the first relay and the second relay may not be simultaneously enabled. Including the relays as non-simultaneous enablement enables one of the power supplies to provide power to the load at a given time. This implementation may provide a smooth transition of de-energizing the first power supply to energizing the second power supply through the enablement and disablement of the multiple relays.

In summary, implementations disclosed herein provide power isolation between a first power supply and a second power supply through an enablement and disablement of multiple relays in connection with the power supplies.

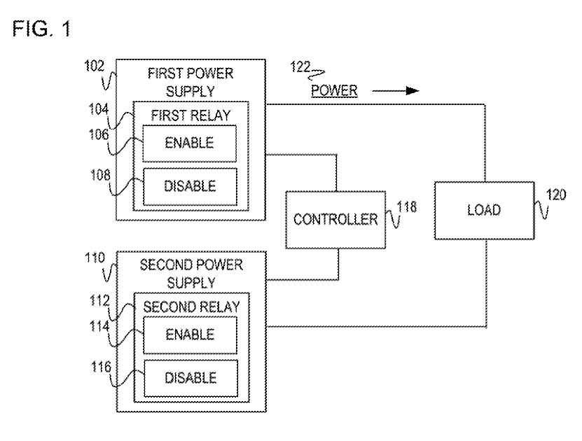

Referring now to the figures, FIG. 1 is a block diagram of an example power system including a first power supply 102 and a second power supply 110. The first power supply 102 is energized by enabling a first relay 104 at module 106. Energizing the first power supply 102 includes delivering power 122 to a load 120. Energizing the first power supply 102, the second power supply 110 remains de-energized through a disablement of a second relay 112 at module 116. A controller 118 monitors the first power supply 102 to detect whether the first power supply 102 experiences a fault. Upon detecting the fault, the controller 118 disables the first relay 104 at module 108, thus de-energizing the first power supply 102. In response to the disablement of the first relay 104 at module 108, the controller 118 enables the second relay 112 at module 114 to energize the second power supply 110. Although FIG. 1 illustrates the power system with power supplies 102 and 110 and the controller 118, this was done for illustration purposes rather than for limiting implementations. For example, the power system may further include a backplane with an output converter to deliver current to the load 120. Implementations of the power system include a power supply system, computing device, computing system, server, distributed power system, or any other power system suitable to support power supplies 102 and 110 to provide power 122 to the load 120.

The first power supply 102 is a primary power supply to provide power 122 within the power system. In one implementation, one of the power supplies 102 or 110 may provide the power 122 to the load 120 at a given time. In this implementation, either of the power supplies 102 or 110 is energized through enabling its respective relay 104 or 112. Energizing one of the power supplies 102 or 110 means enabling one the relays 104 or 112 to provide power 122 to the load 120. De-energizing one or both of the power supplies 102 and 110 means disabling one or both of the relays 104 and 112 so the power supplies 102 and/or 110 may not provide power 122 to the load 120. Although FIG. 1 illustrates the first power supply 102 including first relay 104, implementations should not be limited as this was done for illustration purposes. For example, the first power supply 102 may further include an internal controller (not illustrated) to manage the functioning of the first power supply 102. In one implementation, the first power supply 102 may further include an auxiliary converter to transmit power to the controller 118 for enabling and/or disabling the first relay 104. This implementation may be described in detail in a later figure. Implementations of the first power supply 102 include a power feed, power source, generator, power circuit, energy storage, power system, or other type of power supply capable of providing power 122 to the load 120 upon the enablement of the first relay 104.

The first relay 104 is an electrically operated switch which may be enabled to energize the first power supply 102 to provide the power 122 to the load 120. The controller 118 manages the first relay 104 by transmitting a low-powered signal to the first relay 104 indicating whether to enable or disable the switch at modules 106 and 108. In one implementation, the first relay 104 and the second relay 112 may both be disabled; however, one of the relays 104 and 112 may be enabled at a given time for the respective power supply 102 or 110 to provide power 122 to the load 120. In this implementation, one of the power supplies 102 or 110 is energized at the given time to supply the power 122. Additionally, in this implementation, the first relay 104 and the second relay 112 are not simultaneously enabled. This prevents leakage from one power supply to the other power supply. Implementations of the first relay 104 include a solid state relay, mechanical relay, solid state switch, semiconductor switch, semiconductor relay, or other type of electrically operated switch which may enable and disable at modules 106-108 to provide power 122 to the load 120.

At module 106 the first power supply 102 may receive a low-powered signal from the controller 118 to enable the first relay 104. Enabling the first relay 104 may include connecting the power supply 102 to the load 120 to provide the power 122. Implementations of enabling the first relay 104 include connecting, actuating, closing, energizing, or other type of electrical connection of the first relay 104 to the load 120 to provide the power 122.

At module 108 the first power supply 102 may receive the low-powered signal from the controller 118 to disable the first relay 104. In this implementation, the controller 118 may direct the first power supply 102 to disable the first relay 104 based upon a detection of a fault associated with the first power supply 102. In one implementation, the controller 118 may track a period of time to determine when the first relay 104 may be disabled. Based upon this disablement, the controller 118 may signal to enable the second relay 112 and thus energize the second power supply 110. In this implementation, the first relay 104 may not be fully disabled, meaning power 122 may still be transmitted from the first power supply 102. Thus, the controller 118 may track when power 122 is no longer being transmitted from the first power supply 102 prior to enabling the second relay 112. This prevents the fault that may be detected at the first power supply 102 from affecting the second power supply 110. Implementations of disabling the first relay 104 include disconnecting, de-actuating, de-energizing, opening, or other type of removal of the electrical connection from the first relay 104 to the load 120. In these implementations, by disabling the first relay 104 to the load 120, the first power supply 102 is no longer capable of providing power 122 to the load.

The second power supply 110 is considered a redundant power supply to the first power supply 102. In this sense, the second power supply 110 may be energized to deliver power 122 to the load 120 based on the enablement of the second relay 112 at module 114. The second power supply 110 may be energized to provide the power 122 upon enabling the second relay 112 at module 114 in response to the disablement of the first relay 104. As described in relation to the first power supply 102, although FIG. 1 illustrates the second power supply 110 including second relay 112, implementations should not be limited as this was done for illustration purposes. For example, the second power supply 110 may further include an internal controller (not illustrated) to manage the functioning of the second power supply 110. In one implementation, the second power supply 110 may further include an auxiliary converter to transmit power to the controller 118 for enabling and/or disabling the second relay 112. This implementation may be described in detail in a later figure. Implementations of the second power supply 110 include a power feed, power source, generator, power circuit, energy storage, power system, or other type of power supply capable of providing power 122 to the load 120 upon the enablement of the second relay 112.

The second relay 112 is an electrically operated switch which may be enabled to energize the second power supply 110 rather than the first power supply 102 to provide the power 122 to the load 120. The controller 118 manages the second relay 112 by transmitting low-powered signals to the second power supply 110 directing whether to enable or disable the relay 112 at modules 114 and 116. The second relay 112 is enabled at module 114 upon the disablement of the first relay 104. The second relay 112 is enabled such that the second power supply 110 is energized rather than the first power supply 102 to provide the power 122 to the load 120. Implementations of the second relay 112 include a solid state relay, mechanical relay, solid state switch, semiconductor switch, semiconductor relay, or other type of electrically operated switch which may enable and disable at modules 114-116 to provide power 122 to the load 120.

At module 114, the second power supply 110 may receive low-powered signals from the controller 118 to enable the second relay 112. The second relay 112 may be enabled at module 114 based upon the disablement of the first relay at module 108. In this implementation, the enablement of the second relay 112 is dependent on the disablement of the first relay 104. In this manner, the enablement of the second relay 112 and the enablement of the first relay 104 are mutually exclusive to each other, in the sense the relays 104 and 112 are not both enabled simultaneously at modules 106 and 114. Module 114 may be similar in functionality to module 106 and as such implementations of enabling the second relay 112 include connecting, actuating, closing, energizing, or other type of electrical connection of the second relay 112 to the load 120 to provide the power 122.

At module 116, the second power supply 110 may receive low powered signals from the controller 118 to disable the second relay 112. In one implementation, the second relay 112 and the first relay 104 may both be simultaneously disabled at modules 108 and 116 prior to the enablement of the first relay 104 at module 106. Module 116 may be similar in functionality to module 108 and as such implementations of disabling the second relay 112 include disconnecting, de-actuating, de-energizing, opening, or other type of removal of the electrical connection from the second relay 112 to the load 120 in such a way that the second power supply 110 may not be capable of providing power 122 to the load 120.

The controller 118 may manage the overall functioning of the power system. In this manner, the controller 118 may signal to the first power supply 102 and the second power supply 110 when to enable and/or disable the first relay 104 and the second relay 112, respectively. In one implementation, the controller may monitor the first power supply 102 for fault detection. While monitoring the first power supply 102 for fault detection, the second power supply 110 may remain de-energized through the disablement of the second relay 112. In this implementation, the first power supply 102 provides the power 122 while the second power supply 110 remains powered down. Upon the detection of fault associated with the first power supply 102, the controller 118 communicates to the first power supply 102 to disable the first relay 104. The controller 118 may track the disablement of the first relay 104 and in response to the disablement, the controller 118 communicates to the second power supply 110 to enable the second relay 112. Implementations of the controller 118 include a processor, circuit logic, a set of instructions executable by a processor, a microchip, chipset, electronic circuit, microprocessor, semiconductor, microcontroller, central processing unit (CPU), or other device capable of transmitting low-powered signals to power supplies 102 and 110 to enable and/or disable relays 104 and 112.

The power 122 may be supplied by either the first power supply 102 or the second power supply 110 through enabling the respective relay 104 or 112. Implementations of the power 122 include current, voltage, and/or other electrical charge capable of supplying power to the load 120.

The load 120 receives the power 122 from either the first power supply 102 or the second power supply 110 depending on whether the first relay 104 or the second relay 112 is enabled. Implementations of the load 120 include a server, electrical circuit, electrical impedance, or other type of circuit capable of receiving power 122 from either power supply 102 or 110.

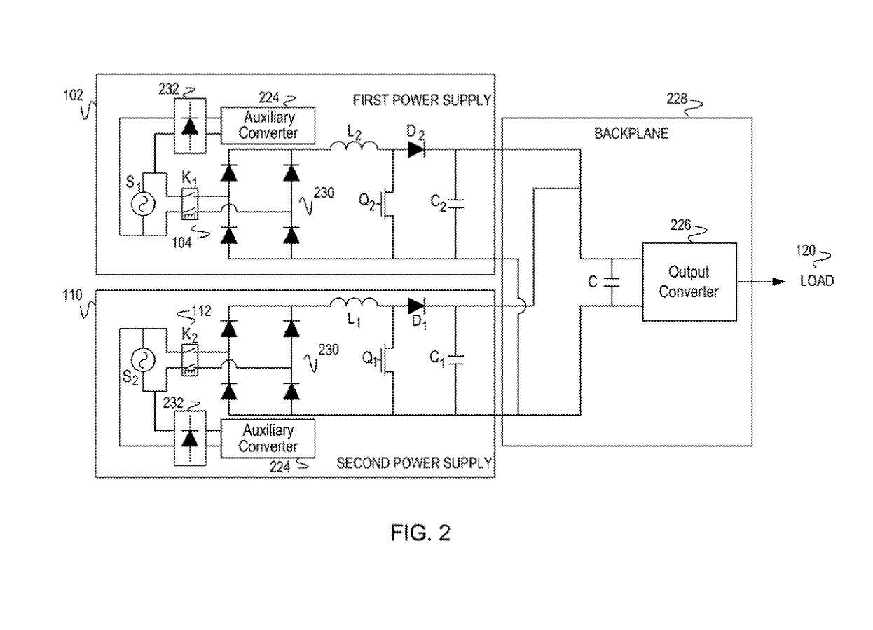

FIG. 2 is a circuit diagram of an example power system including a first power supply 102 and a second power supply 110 connected to an output converter 226. Either the first power supply 102 or the second power supply 110 may provide power through one of multiple diodes (D1-D2) to the output converter on a backplane 228 of the power system and in turn a load 120. Each power supply 102 and 110 includes an input source (S1 and S2) to deliver power to each bridge rectifier 230 based upon an enablement of either a first relay 104 or a second relay 112. The bridge rectifiers 230 and boost converters may receive alternating current (AC) from the respective input source (S1 and S2) and deliver power through the multiple diodes (D1-D2) to charge an output capacitor (C) to deliver energy to the output converter 226. Additionally, each power supply 102 and 110 includes an auxiliary converter 224 which may receive power through a rectifier 232 from the input sources (S1 and S2). The auxiliary converter delivers power to a controller (not illustrated) to signal to the controller which relay 104 or 112 to enable and/or disable.

The multiple diodes (D1-D2) provide additional isolation of power (e.g., current) between the first power supply 102 and the second power supply 110. The multiple diodes (D1-D2) are electrical components that may include minimal resistance in a direction towards the backplane 228, yet includes infinite resistance when current flows in the direction towards either power supply 102 and/or 110. The infinite resistance prevents fault currents from one power supply 102 or 110 from affecting the other power supply 102 and 110. For example, once the output capacitor (C) is charged, the diodes (D1-D2) prevent current from traveling through faults in either power supply 102 or 110.

Each power supply 102 and 110 include the rectifier 232 between the input source (S1 and S2) to each auxiliary converter 224. In one implementation, the rectifiers 232 receive AC and convert the AC to DC for delivery to the auxiliary converters 224. The auxiliary converters 224 supply DC to the controller for the enablement of either the first relay 104 or the second relay 112. In this implementation, each auxiliary converter 224 operates in conjunction with the relays 104 and 112. For example, the auxiliary converter 224 within the first power supply 102 may provide power to the controller on the backplane 228 to enable (e.g., connect) the first relay 104.

The controller is connected to each power supply 102 and 110 and may control the enablement and disablement of the relays 104 and 112. The enabling and disabling of the relays 104 and 112 provides an additional control aspect to a power sequencing of the power supplies 102 and 110.

The bridge rectifiers 230 receive AC through the relays 104 and 112 when enabled and converts the AC to DC for delivery to each boost converter. Each boost converter includes an inductor (L1-L2), a switch (Q1-Q2), a diode (D1-D2), and a capacitor (C1-C2). The boost converter transmits a greater amount of voltage than it receives from each bridge rectifier 230. The capacitors (C1-C2) within each boost converter store energy when the respective power supply 102 or 110 is powered on. This helps facilitate takeover from the first power supply 102 to the second power supply 110. Including these capacitors (C1-C2) reduces wasted capacitance when powering off the first power supply 102 and powering on the second power supply 110. The diodes (D1-D2) isolate power between the first power supply 102 and the second power supply 110. For example, in the first power supply 102, D2 may supply the power to charge C2; however, the diode D1 in the second power supply 110 prevents the other components within the second power supply 110 from affecting capacitor C1.

The output converter 226 may receive the electrical charge from the output capacitor (C) when charged. Charging the output capacitor (C) to provide power to the output converter 226 ensures a minimal interruption of power when switching from the first power supply 102 to the second power supply 110 through disabling the first relay 104 and enabling the second relay 112. The output converter 226 processes the power from the output capacitor (C) for delivery to the load 120. Processing the power may include filtering, conditioning, converting, and/or amplifying prior to transmitting to the load 120. Although FIG. 2 illustrates the backplane 228 of the power system including output capacitor (C) and output converter 226, this was done for illustration purposes and may include other components not illustrated. For example, the backplane 228 may further include the controller to manage the functioning of the power system.

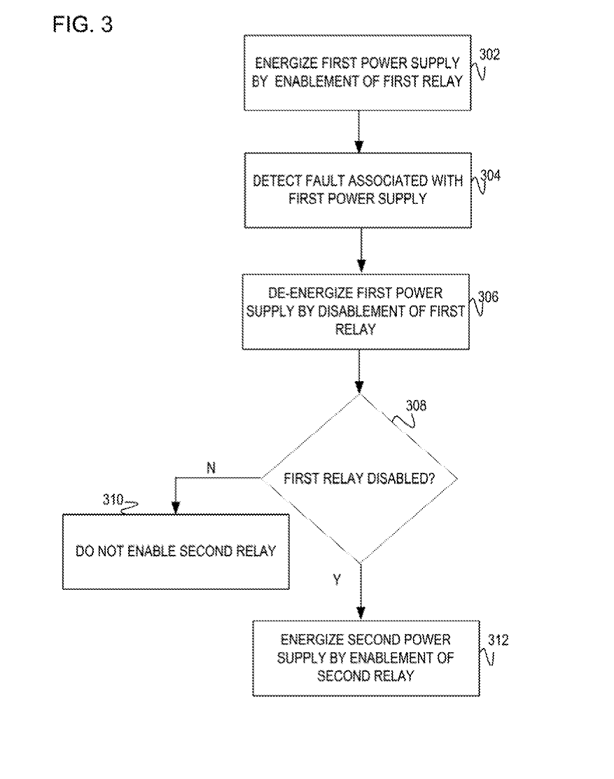

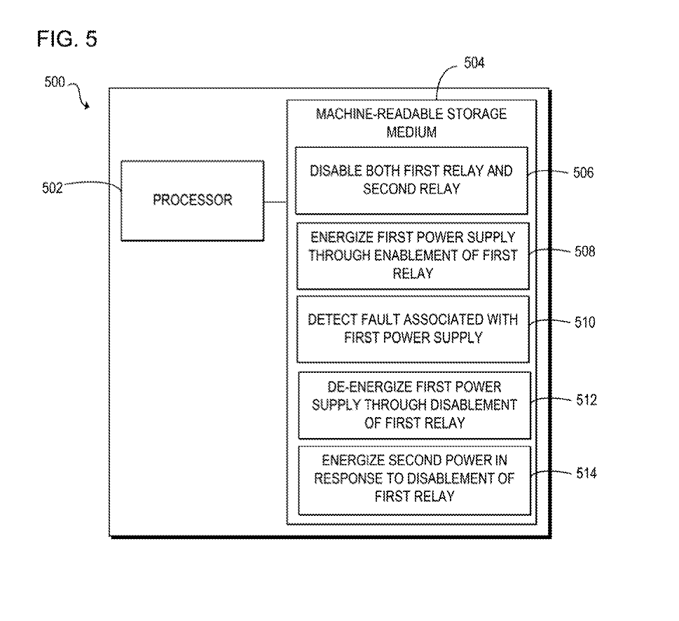

FIG. 3 is a flowchart of an example method, executed by a controller, to energize and de-energize a first and a second power supply within a power system, accordingly. The controller may manage the overall functioning of the power system. The controller energizes the first power supply through an enablement of a first relay while a second power supply remains de-energized through a disablement of a second relay. The controller may proceed to detect a fault associated with the first power supply and based on the detection of this fault, the controller signals to the first power supply to disable the first relay. The disablement of the first relay de-energizes the first power supply, or in other words, the first power supply no longer provides power to a load. Based on the disablement of the first relay, the controller may signal to the second power supply to enable the second relay, thus energizing the second power supply to provide power to the load. Energizing and de-energizing power supplies based on the enablement and disablement of the relays ensures one of the power supplies is de-energized prior to energizing the other power supply. This prevents power (e.g., current) from a faulted power supply from affecting a non-faulted power supply. In discussing FIG. 3, references may be made to the components in FIGS. 1-2 to provide contextual examples. Further, although FIG. 3 is described as implemented by a controller 118 as in FIG. 1, it may be executed on other suitable components. For example, FIG. 3 may be implemented in the form of executable instructions on a machine-readable storage medium, such as machine-readable storage medium 504 as in FIG. 5.

At operation 302, the controller energizes the first power supply through an enablement of the first relay. Energizing the first power supply, ensures the first power supply provides power (e.g., current) to the load. The first relay is an electrically isolated switch internal to the first power supply so the controller may enable the first relay by signaling the first relay to close, connect, energize, actuate, etc. During operation 302, the second power supply remains de-energized (not providing power to the load). The second power supply remains dc-energized by disabling the second relay. The second relay is another electrically isolated switch internal to the second power supply. The first and the second relay use a low-powered signal from the controller to either enable or disable. These relays provide electrical isolation between the controller and the first and second power supplies. In another implementation, prior to energizing the first power supply, the controller may disable both the first and the second relay ensuring both power supplies are de-energized prior to energizing the first power supply at operation 302.

At operation 304, the controller may detect a fault with the first power supply energized at operation 302. The controller may monitor for the fault associated with the first power supply. The fault detected at the first power supply may include an abnormal condition or defect which may lead to a failure of the power supply. In one implementation, the controller may manage the overall functioning of the power system and as such, may include a sensing component to detect when there may be an increase or decrease in power, indicating the fault. In another implementation, the first power supply may include a separate controller to signal to the controller of the overall power system when the first power supply may be experiencing the fault. Detecting the fault of the first power supply at operation 304, the controller may signal to disable the first relay for de-energizing the first power supply at operation 306. Disabling and enabling the relays to energize and de-energize the power supplies provides additional efficiency to the power system to prevent current migration from one power supply to the other.

At operation 306, the controller de-energizes the first power supply by disabling the first relay. In one implementation of operation 306, disabling the first relay may include disabling an auxiliary converter within the first power supply. The auxiliary converter controls an input power off and on to the respective power supply by signaling to the controller when to disable and/or disable the respective relay. Thus, the controller may disable the auxiliary converter and in turn, the first relay. The controller may generate a control signal based on the detected fault within the first power supply at operation 304. The control signal directs the first relay to disable within the first power supply. Disabling the first relay within the first power supply based upon the detection of the fault at operation 304 prevents the fault associated with the first power supply from affecting other power components within the power system.

At operation 308, the controller determines whether the first relay is disabled. In one implementation, if the first relay is not disabled, or in other words, remains enabled, the controller may not enable the second relay as at operation 310. The controller may determine whether the first relay is disabled at operation 308 by tracking a period of time. Once the period of time has passed indicates to the controller the first relay may be disabled. In another implementation, the first relay may include a sensor to communicate with the controller when it may be disabled. Determining whether the first relay is disabled ensures the first power supply is de-energized prior to energizing the second power supply as at operation 312. In this implementation, if the controller determines the first relay is disabled, the controller may energize the second power supply through the enablement of the second relay as at operation 312. In another implementation, the controller may wait until the first relay is fully disabled prior to enabling the second relay as at operation 312.

At operation 310, the controller may not enable the second relay if the first relay is not disabled. In one implementation of operation 310, the controller may delay the enablement of the second relay at operation 312 if the first relay is not yet disabled.

At operation 312, the controller energizes the second power supply through the enablement of the second relay. The controller enables the second relay in response to the disablement of the first relay as at operation 308. In this implementation, the controller may turn the first and the second power supplies on and off through their respective relays. Additionally, in this implementation, the controller switches the power path to prevent circulating power (e.g., current) between the power supplies.

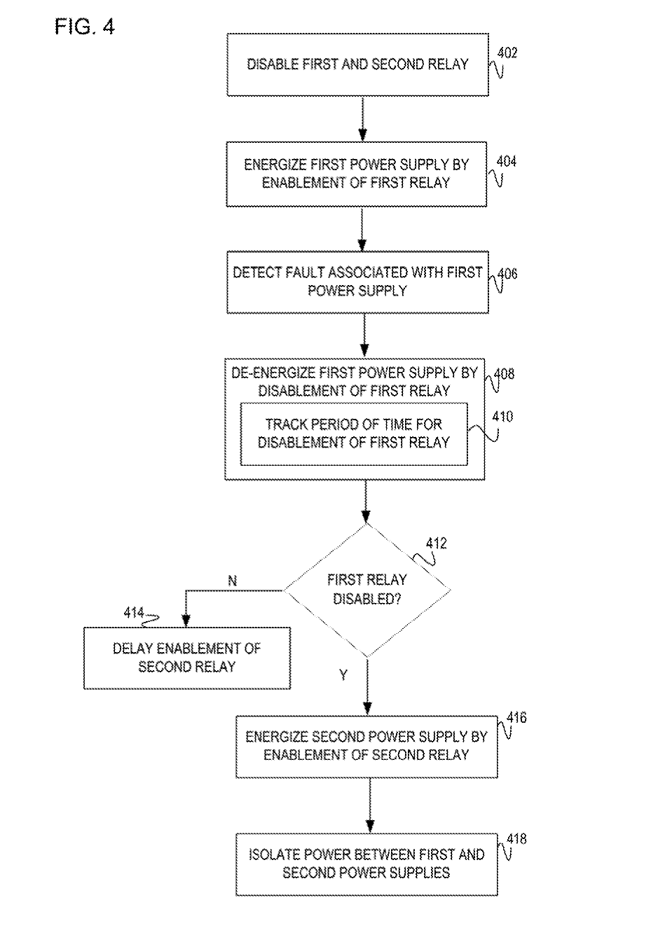

FIG. 4 is a flowchart of an example method, executed by a controller, to disable a first and a second relay for energizing and de-energizing both a first power supply and a second power supply. The controller communicates to both the first power supply and the second power supply to manage the overall functioning of a power system. Specifically, the controller disables both relays and then energizes the first power supply through the enablement of the first relay. Enabling the first relay provides a connection from the first power supply to a load to enable the first power supply to provide power (e.g., current) to the load. During the enablement of the first relay so the first power supply provides the power to the load, the second relay remains disabled so the second power supply is de-energized. In this sense, the second power supply does not provide power to the load. The controller may detect a fault associated with the first power supply and de-energize the first power supply, accordingly by disabling the first relay. Disabling one of the relays includes disconnecting the respective power supply from the load, thus preventing the delivery of power to the load from that respective power supply. Upon the disablement of the first relay, the controller may energize the second power supply by enabling the second relay. Finally, the power delivered to the load may further be isolated between the first and the second power supplies through multiple diodes. In discussing FIG. 4, references may be made to the components in FIGS. 1-2 to provide contextual examples. Further, although FIG. 4 is described as implemented by a controller 118 as in FIG. 1, it may be executed on other suitable components. For example, FIG. 4 may be implemented in the form of executable instructions on a machine-readable storage medium, such as machine-readable storage medium 504 as in FIG. 5.

At operation 402, both the first relay and the second relay are disabled. In this implementation, the first relay and the second relay may be simultaneously disabled; however, in another implementation, the first relay and the second relay may not be simultaneously enabled. Providing the enablement of one relay at a time, ensures the corresponding power supply is energized to provide the power to the load. In this manner, the power to the load is provided by one power supply at a time. Disabling both the relays may include disconnecting each relay from their respective power supply, preventing the power to the load. In another implementation, the controller may operate to verify the first and the second relay are opened (e.g., disconnected), yet both power supplies (i.e., the first and the second power supply) are de-energized. In a further implementation, once a power system powers on, the controller may verify both the first relay and the second relay are disabled prior to energizing the first power supply at operation 404.

At operation 404, the controller communicates with the first power supply to enable the first relay. Enabling the first relay, in turn, energizes the first power supply to provide power (e.g., current) to the load. In one implementation, the first power supply provides current to an output converter which processes the current to provide to the load. In another implementation, an auxiliary converter associated with the first power supply powers the functioning of the first relay. For example, the auxiliary converter provides power to the controller which may be located on a backplane of the power system. In this implementation, the power from the auxiliary converter to the controller, signals which relay to enable/disable. Thus, the auxiliary converter enables the controller to enable and/or disable the first relay. Operation 404 may be similar in functionality to operation 302 as in FIG. 3.

At operation 406, the controller may monitor the first power supply to determine whether a fault is detected from the first power supply. Operation 406 may be similar in functionality to operation 304 as in FIG. 3.

At operation 408, the controller may signal to the first power supply to disable (e.g., disconnect) the first relay so the first power supply is de-energized. De-energizing the first power supply may entail disconnecting the first relay, ensuring power may not be provided to the load from the first power supply. Operation 408 may be similar in functionality to operation 306 as in FIG. 3.

At operation 410, the controller may track a period of time for the disablement of the first relay. In this implementation, the controller communicates with the first power supply to open the first relay and may determine when the period of time has passed, ensuring the disablement of the first relay. The period of time may be defined by an administrator of the power system. In one implementation, once the period of time has passed, the controller may include an additional delay prior to signaling to the second power supply to enable (e.g., connect) the second relay as at operation 414.

At operation 412, the controller may determine whether the first relay is disabled. Upon the disablement of the first relay, the controller may enable the second relay to energize the second power supply. In one implementation, the controller may determine whether the first relay is fully disabled indicating the first power supply is no longer capable of providing power to the load. Operation 412 may be similar in functionality to operation 308 as in FIG. 3.

At operation 414, upon determining the first relay may not be disabled such as at operation 412, the controller may delay the enablement of the second relay at operation 416. In this implementation, the controller may wait an additional period of time, ensuring the first relay may be disabled (e.g., disconnected) from the first power supply preventing the flow of power to the load. In this implementation, the controller tracks the disablement of the first relay through time rather than a sensing circuit to monitor the disablement of the first relay. In another implementation, the controller may track the disablement of the first relay through the sensing circuit. The sensing circuit may determine when the first relay is connected and/or disconnected within the first power supply to communicate to the controller. This enables the controller to track when the first relay is enabled and/or disabled to proceed to operation 414 and/or operation 416, accordingly.

At operation 416, the controller may communicate with the second power supply to enable the second relay. Enabling the second relay energizes the second power supply in the sense that the second power supply is capable of providing power to the load. Switching from de-energizing the first power supply to energizing the second power supply, each power supply at a given time may provide current to a capacitor. The capacitor may provide power to the load when switching from de-energizing the first power supply to energizing the second power supply to mitigate an interruption in the flow of power to the load. Operation 416 may be similar in functionality to operation 312 as in FIG. 3.

At operation 418, the power system may isolate power (e.g., current) between the first and the second power supplies through multiple diodes. The power isolation provided at operation 418 may be provided in addition to the power isolation provided from enabling and/or disable relays to energize and/or de-energize the respective power supplies.

FIG. 5 is a block diagram of an example computing device 500 with a processor 502 to execute instructions 506-514 in a machine-readable storage medium 504. The processor 502 executes instructions 506-514 for disabling a first relay and enabling a second relay for energizing/de-energizing a first power supply and energizing a second power supply through the first and the second relay, accordingly. Although the computing device 500 includes processor 502 and machine-readable storage medium 504, it may also include other components that would be suitable to one skilled in the art. For example, the computing device 500 may include the controller 118 as in FIG. 1. The computing device 500 is an electronic device with the processor 502 capable of executing instructions 506-514, and as such embodiments of the computing device 500 include a mobile device, client device, personal computer, desktop computer, laptop, tablet, video game console, or other type of electronic device capable of executing instructions 506-514. The instructions 506-514 may be implemented as methods, functions, operations, and other processes implemented as machine-readable instructions stored on the storage medium 504, which may be non-transitory, such as hardware storage devices (e.g., random access memory (RAM), read only memory (ROM), erasable programmable ROM, electrically erasable ROM, hard drives, and flash memory).

The processor 502 may fetch, decode, and execute instructions 506-514 to energize and de-energize multiple power supplies through enabling and disabling respective relays, accordingly. In one implementation upon executing instruction 506, the processor 502 may proceed to execute instructions 508-514. In another implementation, the processor 502 may proceed to executing instructions 508-514 without executing instruction 506. Specifically, the processor 502 may execute instruction 506 to disable both the first relay and the second relay, thus de-energizing both the first and the second power supplies. Additionally, the processor 502 may execute instructions 508-514 to: energize the first power supply through enabling the first relay while the second power supply remains de-energized; detecting a fault associated with the first power supply; de-energizing the first power supply by disabling the first relay; and enabling the second relay to energize the second power supply in response to the disablement of the first relay. Implementations of the processor 502 may include an integrated circuit, a microchip, processor, chipset, electronic circuit, microprocessor, semiconductor, microcontroller, central processing unit (CPU), graphics processing unit (GPU), semiconductor, or other type of programmable device capable of executing instructions 506-514.

The machine-readable storage medium 504 includes instructions 506-514 for the processor 502 to fetch, decode, and execute. In another embodiment, the machine-readable storage medium 504 may be an electronic, magnetic, optical, memory, storage, flash-drive, or other physical device that contains or stores executable instructions. Thus, the machine-readable storage medium 504 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 504 may include an application and/or firmware which can be utilized independently and/or in conjunction with the processor 502 to fetch, decode, and/or execute instructions of the machine-readable storage medium 504. The application and/or firmware may be stored on the machine-readable storage medium 504 and/or stored on another location of the computing device 500.

In summary, implementations disclosed herein provide electrical isolation between multiple power supplies through enabling and disabling relays for energizing and de-energizing the multiple power supplies.

We claim:

1. A method, executed by a controller, the method comprising:
energizing a first power supply through an enablement of a first relay to provide power to a load while a second power supply remains de-energized through a disablement of a second relay;
detecting a fault associated with the first power supply;
de-energizing the first power supply through a disablement of the first relay; and
energizing the second power supply through an enablement of the second relay to provide power to the load, in response to the disablement of the first relay.

2. The method of claim 1 wherein the first relay and the second relay are not simultaneously enabled, the non-simultaneous enablement prevents current migration between the first and the second power supplies.

3. The method of claim 1 wherein de-energizing the first power supply through the disablement of the first relay is further comprising:
tracking a period of time for the disablement of the first relay.

4. The method of claim 1 further comprising:
disabling the first relay and the second relay prior to energizing the first power supply through the enablement of the first relay.

5. The method of claim 1 further comprising:
isolating the power between the first power supply and the second power supply through multiple diodes.

6. The method of claim 1 wherein if the first relay is not disabled, the method is further comprising:
delaying the enablement of the second relay for a period of time.

7. A system comprising:
a controller to detect a fault associated with a first power supply;
a first power supply to:
enable a first relay to deliver power to a load while a second relay remains disabled;
disable the first relay based on the detected fault; and
a second power supply to enable the second relay to provide the power to the load, in response to the disablement of the first relay.

8. The system of claim 7 further comprising:
multiple diodes to isolate the power between the first power supply and the second power supply; and
an output converter to process the power from the first and second power supplies for delivery to the load.

9. The system of claim 7 further comprising:
a first rectifier, associated with the first power supply, to receive alternating current from an input source and deliver direct current to a first auxiliary converter; and
a second rectifier, associated with the second power supply, to receive alternating current from the input source and deliver direct current to a second auxiliary converter.

10. The system of claim 9 further comprising:
the first auxiliary converter, to supply the direct current to the controller for enablement of the first relay; and
the second auxiliary converter to supply the direct current to the controller for enablement of the second relay.

11. The system of claim 7 wherein the power includes current and each power supply is further comprising:
a bridge rectifier to receive alternating current from a respective relay and convert the alternating current to direct current; and
a boost converter to receive the direct current from the bridge rectifier and process the direct current for delivery to an output converter.

12. The system of claim 7 wherein the first relay and the second relay are each located between an input source and the load and further wherein the first relay and the second relay are not simultaneously enabled.

13. A non-transitory machine-readable storage medium encoded with instructions executable by a processor of a computing device, the storage medium comprising instructions to:
energize a first power supply through an enablement of a first relay to provide power to a load, while a second power supply remains de-energized through a disablement of a second relay;
detect a fault associated with the first power supply;
de-energize the first power supply through a disablement of the first relay; and
energize the second power supply through an enablement of the second relay to provide power to the load, in response to the disablement of the first relay.

14. The non-transitory machine-readable storage medium including the instructions of claim 13 further comprising instructions to:
disable both the first relay and the second relay prior to energizing the first power supply through the enablement of the first relay.

15. The non-transitory machine-readable storage medium including the instructions of claim 13 wherein to energize the second power supply through the enablement of the second relay is further comprising instructions to:
receive direct current from an auxiliary converter for the enablement of the second relay.
